(19) United States
(12) Patent Application Publication
(10) Pub. No.: US 2026/0285341 A1
(43) Pub. Date: Sep. 24, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventor: Yugo Kajiwara, Tokyo (JP)

(21) Appl. No.: 19/534,864

(22) Filed: Feb. 10, 2026

(30) Foreign Application Priority Data
Mar. 19, 2025 (JP) 2025-045596

(51) Int. Cl. B60W 50/08; B60W 10/04; B60W 10/18; B60W 10/20

(52) U.S. Cl. CPC B60W 50/085; B60W 10/04; B60W 10/18; B60W 10/20; B60W 2510/205; B60W 2540/10; B60W 2540/12; B60W 2540/18; B60W 2552/10; B60W 2710/20; B60W 2720/106

(57) ABSTRACT

A travel control device comprises a travel control unit that automatically controls acceleration/deceleration and steering of a vehicle, and a manual operation acquisition unit that acquires manual operation information related to a manual operation performed by an occupant of the vehicle, wherein when only the manual operation information related to one of the acceleration/deceleration and the steering is acquired, the travel control unit, when the manual operation information satisfies a first condition, continues both the automatic control related to the acceleration/deceleration and the automatic control related to the steering while changing control content of the automatic control according to the manual operation information satisfying the first condition, and when the manual operation information satisfies a second condition, cancels only the automatic control related to that of the acceleration/deceleration and the steering for which the manual operation information has been acquired.

### CROSS-REFERENCE TO RELATED APPLICATION

This application claims priority based on Japanese Patent Application No. 2025-045596 filed in Japan on March 19, 2025, and the entire contents thereof are incorporated herein by reference.

### BACKGROUND OF THE INVENTION

### Field of the Invention

The present invention relates to a travel control device, a travel control method, and a storage medium.

### Description of Related Art

In recent years, efforts to provide access to sustainable transportation systems that also consider people in vulnerable positions among traffic participants have been intensifying. Toward this realization, efforts are being focused on research and development to further improve traffic safety and convenience through research and development related to automated driving technology.

In relation to this, conventionally, a technology is known in which, during automated driving, when there is a manual operation related to one of an acceleration/deceleration operation and a steering operation by an occupant, automatic control related to that of acceleration/deceleration and steering for which the manual operation has been performed is canceled and a shift to semi-automated driving is made (for example, see Patent Document 1 below). For example, in the technology of Patent Document 1, during automated driving, when there is a manual operation related to both an acceleration/deceleration operation and a steering operation by an occupant, both automatic controls related to acceleration/deceleration and automatic control related to steering are canceled, and a shift to manual driving is made.

[Patent Document 1] Japanese Unexamined Patent Application, First Publication No. 2019-89546

### SUMMARY OF THE INVENTION

In conventional automated driving technology, when an occupant wants to overtake a preceding vehicle and manually operates the steering wheel, for example, the manual operation may be determined as an intention by the occupant to start manual driving, and part or all of the automated driving may be canceled. In this case, automated driving is canceled contrary to the occupant's intention, and the occupant may feel bothered. As described above, in conventional automated driving technology, there has been an issue that an occupant's intention cannot necessarily be accurately reflected with respect to continuation of automated driving or a shift from automated driving to semi-automated driving or manual driving.

An aspect according to the present invention has been made in consideration of such circumstances, and one object thereof is to provide a travel control device, a travel control method, and a storage medium capable of executing driving control according to an occupant's intention. Further, it contributes to the development of sustainable transportation systems.

In order to solve the above problem, the present invention adopts the following aspects.
(1): A travel control device according to one aspect of the present invention comprises a travel control unit that automatically controls acceleration/deceleration and steering of a vehicle, and a manual operation acquisition unit that acquires manual operation information related to a manual operation performed by an occupant of the vehicle, wherein when the manual operation information related to one of the acceleration/deceleration and the steering is acquired, and the manual operation information related to the other of the acceleration/deceleration and the steering is not acquired, the travel control unit, when the manual operation information satisfies a first condition, continues both the automatic control related to the acceleration/deceleration and the automatic control related to the steering while changing control content of the automatic control according to the manual operation information satisfying the first condition, and when the manual operation information satisfies a second condition in which an operation intensity is greater than in the first condition, cancels the automatic control related to that of the acceleration/deceleration and the steering for which the manual operation information has been acquired, and continues the automatic control related to that of the acceleration/deceleration and the steering for which the manual operation information has not been acquired.
(2): In the aspect of (1) above, when the manual operation information related to the steering is acquired, the first condition may be that both a steering operation amount and a steering speed are less than a threshold, and the second condition may be that one of the steering operation amount and the steering speed is equal to or greater than a threshold, and the other of the steering operation amount and the steering speed is less than a threshold.
(3): In the aspect of (2) above, the second condition may be that the steering operation amount is equal to or greater than a threshold, and the steering speed is less than a threshold.
(4): In the aspect of (1) above, the travel control unit may cancel both the automatic control related to the acceleration/deceleration and the automatic control related to the steering when the manual operation information satisfies a third condition in which an operation intensity is greater than the second condition.
(5): In the aspect of (4) above, when the manual operation information related to the steering is acquired, the third condition may be that both the steering operation amount and the steering speed are equal to or greater than a threshold.
(6): In the aspect of (4) above, when the manual operation information related to the steering is acquired, the second condition may be performing a lane change, and the third condition may be performing a right or left turn.
(7): In the aspect of (1) above, when the manual operation information related to the acceleration/deceleration is acquired, the first condition may be that both an operation amount of an acceleration/deceleration operator and an operation speed of the acceleration/deceleration operator are less than a threshold, and the second condition may be that one of the operation amount of the acceleration/deceleration operator and the operation speed of the acceleration/deceleration operator is equal to or greater than a threshold, and the other of the operation amount of the acceleration/deceleration operator and the operation speed of the acceleration/deceleration operator is less than a threshold.
(8): In the aspect of (4) above, when the manual operation information related to the acceleration/deceleration is acquired, the third condition may be that both the operation amount of the acceleration/deceleration operator and the operation speed of the acceleration/deceleration operator are equal to or greater than a threshold.
(9): A travel control method according to one aspect of the present invention is a method in which a computer automatically controls acceleration/deceleration and steering of a vehicle, acquires manual operation information related to a manual operation performed by an occupant of the vehicle, and when the manual operation information related to one of the acceleration/deceleration and the steering is acquired, and the manual operation information related to the other of the acceleration/deceleration and the steering is not acquired, when the manual operation information satisfies a first condition, continues both the automatic control related to the acceleration/deceleration and the automatic control related to the steering while changing control content of the automatic control according to the manual operation information satisfying the first condition, and when the manual operation information satisfies a second condition in which an operation intensity is greater than in the first condition, cancels the automatic control related to that of the acceleration/deceleration and the steering for which the manual operation information has been acquired, and continues the automatic control related to that of the acceleration/deceleration and the steering for which the manual operation information has not been acquired.
(10): A computer-readable non-transitory storage medium according to one aspect of the present invention stores a program that causes a computer to automatically control acceleration/deceleration and steering of a vehicle, acquire manual operation information related to a manual operation performed by an occupant of the vehicle, and when the manual operation information related to one of the acceleration/deceleration and the steering is acquired, and the manual operation information related to the other of the acceleration/deceleration and the steering is not acquired, when the manual operation information satisfies a first condition, continue both the automatic control related to the acceleration/deceleration and the automatic control related to the steering while changing control content of the automatic control according to the manual operation information satisfying the first condition, and when the manual operation information satisfies a second condition in which an operation intensity is greater than in the first condition, cancel the automatic control related to that of the acceleration/deceleration and the steering for which the manual operation information has been acquired, and continue the automatic control related to that of the acceleration/deceleration and the steering for which the manual operation information has not been acquired.

According to the aspects of (1) to (10) above, driving control according to an occupant's intention can be executed.

### BRIEF DESCRIPTION OF THE DRAWINGS

FIG. 1 is a configuration diagram of a vehicle system including a travel control device according to an embodiment.

FIG. 2 is a configuration diagram of a manual operation unit according to the embodiment.

FIG. 3 is a functional configuration diagram of a first control unit and a second control unit according to the embodiment.

FIG. 4 is a diagram for explaining an example of route determination and target trajectory generation in a case of a first mode.

FIG. 5 is a diagram for explaining an example of route determination and target trajectory generation in a case of a second mode.

FIG. 6 is a diagram showing an example of first information.

FIG. 7 is a diagram showing an example of second information.

FIG. 8 is a diagram for explaining an example of driving control in a case where manual operation information related to steering satisfies a first condition.

FIG. 9 is a diagram for explaining an example of driving control in a case where manual operation information related to steering satisfies a second condition.

FIG. 10 is a diagram for explaining an example of driving control in a case

where manual operation information related to steering satisfies a third condition.

FIG. 11 is a flowchart showing an example of a flow of processing executed by an automated driving control device when a manual operation related to steering is performed during execution of automated driving.

FIG. 12 is a flowchart showing an example of a flow of processing executed by an automated driving control device when a manual operation related to acceleration/deceleration is performed during execution of automated driving.

### DETAILED DESCRIPTION OF THE INVENTION

Hereinafter, embodiments of a travel control device, a travel control method, and a storage medium of the present invention will be described with reference to the drawings. Hereinafter, as an example, an embodiment in which a travel control device is applied to an automated driving vehicle will be described. Automated driving is, for example, executing driving control by automatically controlling (that is, automatic control) both steering and speed of a vehicle. Examples of the above-described driving control may include driving control such as an Adaptive Cruise Control System (ACC), Traffic Jam Pilot (TJP), Lane Keeping Assistance System (LKAS), Automated Lane Change (ALC), and Collision Mitigation Brake System (CMBS). In the automated driving vehicle, driving control according to a manual operation (so-called manual driving) of a user (for example, an occupant) of the vehicle may be executed. In an automated driving vehicle, driving control (so-called semi-automated driving) in which automated driving and manual driving are used together may be executed. In semi-automated driving, for example, one of acceleration/deceleration and steering of a vehicle is automatically controlled, and the other of acceleration/deceleration and steering is controlled by manual operation of a user of the vehicle. In the following description, a case will be described in which the left-hand driving regulations are applied, but when the right-hand driving regulations are applied, left and right may be read in reverse.

### Overall Configuration

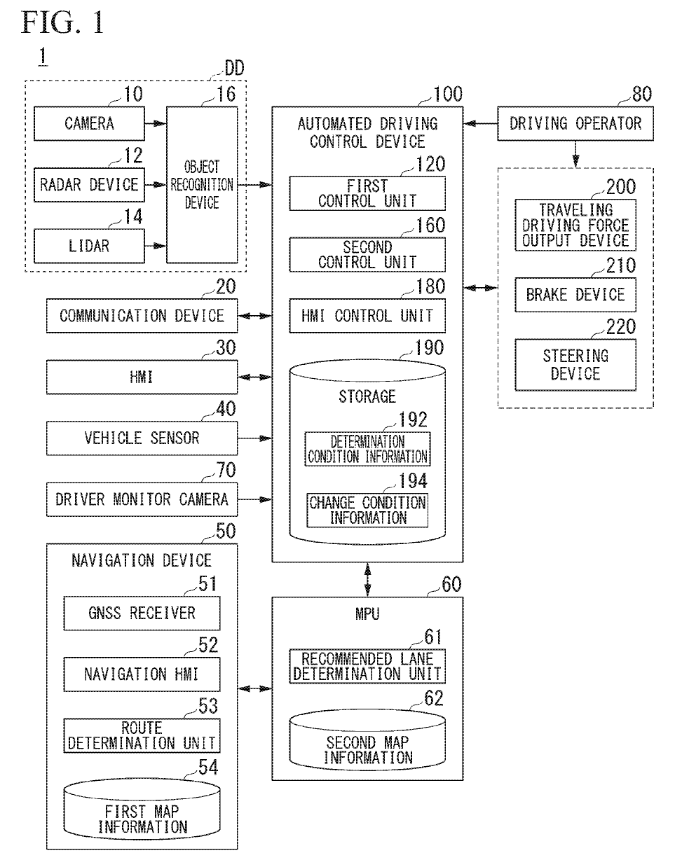

FIG. 1 is a configuration diagram of a vehicle system 1 including a travel control device according to an embodiment. A vehicle (hereinafter referred to as a vehicle M) in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generation unit connected to the internal combustion engine or discharge electric power of a battery (power storage) such as a secondary battery or a fuel cell.

The vehicle system 1 includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an MPU (Map Positioning Unit) 60, a manual operation unit 80, an automated driving control device 100, a traveling driving force output device 200, a brake device 210, and a steering device 220. These devices and equipment are connected to each other by multiple communication lines, such as a control unit area network (CAN) communication line, serial communication lines, wireless communication networks, or the like. Further, the configuration shown in FIG. 1 is merely an example, and some of the configuration may be omitted, or other configurations may be added. The camera 10 is an example of an "imaging unit". A combination of the camera 10, the radar device 12, the LIDAR 14, and the object recognition device 16 is an example of a “detection device DD.” The HMI 30 is an example of a "reception unit" or an "output unit". The automated driving control device 100 is an example of a "travel control device".

For example, the camera 10 is a digital camera using a solid-state imaging element such as, for example, a charge-coupled device (CCD) or a complementary metal oxide semiconductor (CMOS). The camera 10 is attached to any location on the vehicle M in which the vehicle system 1 is mounted. For example, when the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the side of the vehicle M are imaged, the camera 10 is attached to a door mirror, or the like. The camera 10 captures images of the surroundings of the vehicle M repeatedly, for example, periodically. The camera 10 may also be a stereo camera.

The radar device 12 radiates radio waves such as millimeter waves to the surroundings of the vehicle M and detects radio waves (reflected waves) reflected by surrounding objects to detect at least the position (distance and direction) of the objects. The radar device 12 is attached to the vehicle M at an arbitrary location. The radar device 12 may detect the position and speed of the object using a frequency modulated continuous wave (FM-CW) method.

The LIDAR 14 radiates light to the vicinity of the vehicle M and measures scattered light. The LIDAR 14 detects the distance to the subject on the basis of the time between light emission and reception. The emitted light is, for example, a pulsed laser beam. The LIDAR 14 is attached to an arbitrary position of the vehicle M.

The object recognition device 16 executes sensor fusion processing on some or all of the detection results from the camera 10, the radar device 12, and the LIDAR 14 to recognize the position, type, speed, etc. of the object. The object recognition device 16 outputs the recognition results to the automated driving control device 100. The object recognition device 16 may output the detection results of the camera 10, the radar device 12, and the LIDAR 14 to the automated driving control device 100 as they are. In this case, the object recognition device 16 may be omitted from a configuration of the vehicle system 1 (the detection device DD).

The communication device 20 communicates with, for example, other vehicles existing in the vicinity of the vehicle M, a terminal device of a user using the vehicle M, or various server devices by using a network such as a cellular network, a Wi-Fi network, Bluetooth (registered trademark), DSRC (Dedicated Short Range Communication), a LAN (Local Area Network), a WAN (Wide Area Network), or the Internet.

The HMI 30 outputs various types of information to the occupant of the vehicle M and receives input operations by the occupant. The HMI 30 includes, for example, various display devices, speakers, buzzers, touch panels, switches, keys, and microphones. Examples of the display device include a liquid crystal display (LCD) device and an organic electroluminescence (EL) display device. The display device is provided in the vicinity of the front of a driver’s seat (a seat closest to the steering wheel) on an instrument panel and is installed at a position which can be seen by an occupant through a gap of the steering wheel or over the steering wheel. The display device may be installed at the center of the instrument panel. The display device may be a head-up display (HUD). The HUD allows an occupant sitting on the driver’s seat to see a virtual image by projecting an image to a part of a front windshield in front of the driver’s seat. The display device displays an image which is generated by the HMI control unit 180 which will be described later. The HMI 30 may include a driving switching switch or the like that mutually switches among automated driving, semi-automated driving, and manual driving by an occupant.

The vehicle sensor 40 includes a vehicle speed sensor configured to detect the speed of the vehicle M, an acceleration sensor configured to detect acceleration, a yaw rate sensor configured to detect a yaw rate (for example, a rotational angular velocity around a vertical axis passing through the center of gravity of the vehicle M), a direction sensor configured to detect the direction of the vehicle M, and the like. The vehicle sensor 40 may be provided with a position sensor that detects a position of the vehicle. The position sensor is, for example, a sensor that acquires position information (longitude and latitude information) from a global positioning system (GPS) device. The position sensor may be a sensor that acquires the positional information using a global navigation satellite system (GNSS) receiver 51 of the navigation device 50. The vehicle sensor 40 may derive the speed of the vehicle M from a difference (that is, a distance) in positional information at a predetermined time in the position sensor. A detection result of the vehicle sensor 40 is output to the automated driving control device 100.

The navigation device 50 includes, for example, a GNSS receiver 51, a navigation HMI 52, and a route determination unit 53. In the navigation device 50, first map information 54 is retained in a storage device such as a hard disk drive (HDD) or a flash memory. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The GNSS receiver 51 may be provided in the vehicle sensor 40. The navigation HMI 52 may be partially or completely shared with the HMI 30 described above. The route determination unit 53 determines, for example, a route (hereinafter, a route on map) to a destination input by an occupant using the navigation HMI 52 from a position of the vehicle M (or an arbitrary position that was input) specified by the GNSS receiver 51 with reference to the first map information 54. The first map information 54 is, for example, information that represents a shape of a road using links that indicate roads and nodes connected by the links. The first map information 54 may include point of interest (POI) information, and the like. The route on map is output to the MPU 60. The navigation device 50 may perform route guidance using the navigation HMI 52 on the basis of the route on map. The navigation device 50 may transmit the current position and destination to a navigation server via the communication device 20 and acquire the same route as the route on map from the navigation server. The navigation device 50 outputs a determined route on the map to the MPU 60.

The MPU 60 includes, for example, a recommended lane determination unit 61 and stores second map information 62 in a storage device such as an HDD or a flash memory. The recommended lane determination unit 61 divides the route on the map provided from the navigation device 50 into a plurality of blocks (e.g., divides the route every 100 [m] in a traveling direction of the vehicle), and determines a recommended lane for each block with reference to the second map information 62. The recommended lane determination unit 61 determines which lane from the left the vehicle travels on. When a branch point exists in the on-map route, the recommended lane determination unit 61 determines a recommended lane so that the vehicle M can travel on a rational route for proceeding to the branch destination.

The second map information 62 is map information with higher accuracy than the first map information 54. The second map information 62 includes, for example, road types, the number of lanes, types and shapes of road lane markings (hereinafter referred to as lane markings), information on the center of lanes or information on road boundaries, and the like. The second map information 62 may include road shape information, traffic regulation information, address information (address/postal code), facility information, parking lot information, telephone number information, and the like. The road shape information is, for example, types of intersections (crossroads, T-junctions, Y-junctions, roundabouts, etc.), branches, merges, lane increase/decrease points, curvature of a road (may be rephrased as radius of curvature; the same applies hereinafter), curvature change amount for each predetermined distance, width, gradient, and the like.

The second map information 62 may include information related to a line (center line) indicating the center of a lane. The center line is a center line between left and right lane markings. This center line may exist in a lane in which one of the left and right lane markings that demarcate the lane is interrupted.

The second map information 62 may be updated at any time by the communication device 20 communicating with an external device. The first map information 54 and the second map information 62 may be integrally provided as map information. The map information may be stored in the storage 190.

The driver monitor camera 70 is, for example, a digital camera that uses a solid-state imaging element such as a CCD or a CMOS. The driver monitor camera 70 is attached to an arbitrary position on the vehicle M in a place and a direction in which the head of an occupant (a driver) sitting on a driver’s seat of the vehicle M can be imaged from the front (such that the face of the driver is imaged). For example, the driver monitor camera 70 is attached to an upper part of a display device which is provided at the center of the instrument panel of the vehicle M.

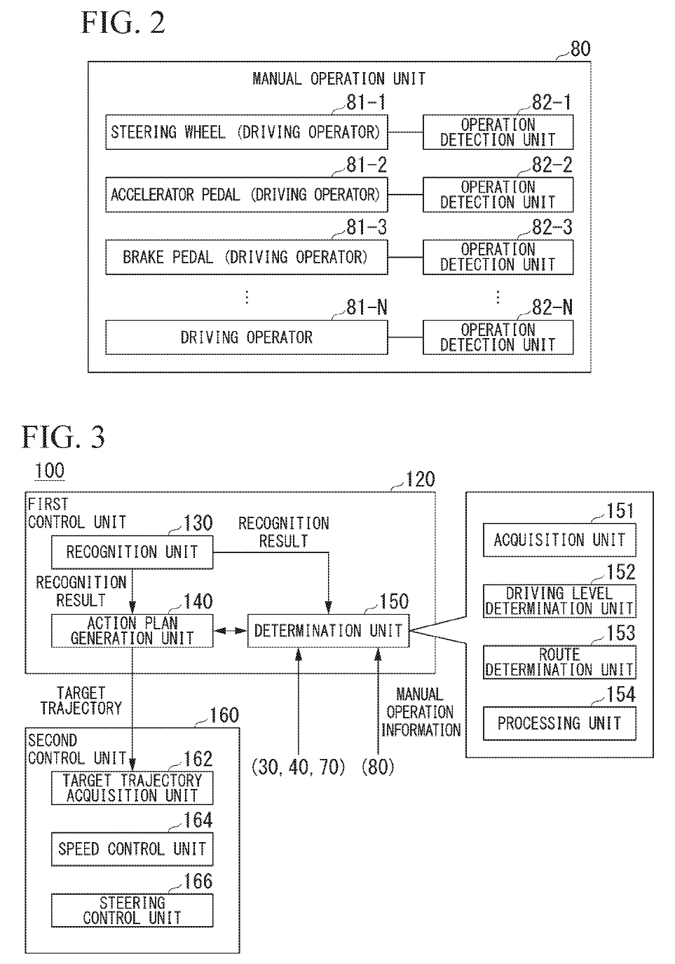

As shown in FIG. 2, the manual operation unit 80 includes, for example, at least one driving operator 81-1 to 81-N, and at least one operation detection unit 82-1 to 82-N.

The driving operators 81-1 to 81-N are devices that are manually operated by an occupant (driver) for manual control of the vehicle M. The driving operators 81-1 to 81-N may include a steering operator for controlling (manually controlling) steering of the vehicle M by manual operation of an occupant, and an acceleration/deceleration operator for controlling (manually controlling) acceleration/deceleration of the vehicle M by manual operation of the occupant. The acceleration/deceleration operator may include an acceleration operator for acceleration of the vehicle M and a deceleration operator for deceleration of the vehicle M. The manual operation unit 80 may include a driving operator that corresponds to neither the steering operator nor the acceleration/deceleration operator.

The manual operation unit 80 according to the embodiment includes, as driving operators, a steering wheel 81-1, an accelerator pedal 81-2, and a brake pedal 81-3. Here, the steering wheel 81-1 is an example of a steering operator. Each of the accelerator pedal 81-2 and the brake pedal 81-3 is an example of an acceleration/deceleration operator. In particular, the accelerator pedal 81-2 is an example of an acceleration operator, and the brake pedal 81-3 is an example of a deceleration operator. The manual operation unit 80 may include, in addition to or instead of these driving operators, a shift lever, a modified steering wheel, a joystick, or other driving operators.

The operation detection units 82-1 to 82-N detect an operation amount of a manual operation performed by an occupant on the driving operators 81-1 to 81-N, presence or absence of a manual operation, a speed of the manual operation (operation speed), and the like. For example, the operation detection units 82-1 to 82-N are provided so as to correspond one-to-one with the driving operators 81-1 to 81-N, and each of the operation detection units 82-1 to 82-N may detect an operation amount, presence or absence, speed, and the like of a manual operation on a corresponding one of the driving operators 81-1 to 81-N.

For example, the operation detection unit 82-1 corresponding to the steering wheel 81-1 may detect a steering angle, a steering torque, and a steering speed of the steering wheel 81-1. The steering angle and the steering torque of the steering wheel 81-1 are an example of an "operation amount of the steering operator (steering operation amount)". The steering speed of the steering wheel 81-1 is an example of an "operation speed of the steering operator (steering speed)". The operation detection unit 82-2 corresponding to the accelerator pedal 81-2 may detect a depression amount and a depression speed of the accelerator pedal 81-2. The depression amount of the accelerator pedal 81-2 is an example of an "operation amount of the acceleration/deceleration operator" and an example of an "operation amount of the acceleration operator". The depression speed of the accelerator pedal 81-2 is an example of an "operation speed of the acceleration/deceleration operator" and an example of an "operation speed of the acceleration operator". The operation detection unit 82-3 corresponding to the brake pedal 81-3 may detect a depression amount and a depression speed of the brake pedal 81-3. The depression amount of the brake pedal 81-3 is an example of an "operation amount of the acceleration/deceleration operator" and an example of an "operation amount of the deceleration operator". The depression speed of the brake pedal 81-3 is an example of an "operation speed of the acceleration/deceleration operator" and an example of an "operation speed of the deceleration operator".

The manual operation unit 80 (operation detection units 82-1 to 82-N) outputs detection results to one or both of the automated driving control device 100 or the traveling driving force output device 200, the brake device 210, and the steering device 220. Hereinafter, information (detection results) detected by the operation detection units 82-1 to 82-N is referred to as "manual operation information". The manual operation information is information related to a manual operation performed by an occupant of the vehicle M on the driving operators 81-1 to 81-N. The manual operation information may include information related to a manual operation related to steering (that is, a manual operation on the steering operator) and information related to a manual operation related to acceleration/deceleration (that is, a manual operation on the acceleration/deceleration operator). When the manual operation unit 80 includes a driving operator (hereinafter referred to as an auxiliary operator) that corresponds to neither the steering operator nor the acceleration/deceleration operator, the manual operation information may include information (for example, an operation amount and an operation speed of the auxiliary operator) related to a manual operation performed by an occupant on the auxiliary operator.

Returning to FIG. 1, the automated driving control device 100 executes various driving controls belonging to automated driving for the vehicle M. The automated driving control device 100 includes, for example, a first control unit 120, a second control unit 160, an HMI control unit 180, and a storage 190. The first control unit 120, the second control unit 160, and the HMI control unit 180 are realized, for example, by causing a hardware processor such as a central processing unit (CPU) to execute a program (software). Some or all of such constituent elements may be realized by hardware (a circuit unit; including circuitry) such as a large scale integration (LSI), an application specific integrated circuit (ASIC), a field-programmable gate array (FPGA), a graphics processing unit (GPU), and a system on chip (SOC) or may be realized by software and hardware in cooperation. The program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like. The HMI control unit 180 is an example of an “output control unit.”

The storage 190 may be implemented by the above-described various storage devices, an electrically erasable programmable read-only memory (EEPROM), a read-only memory (ROM), a random-access memory (RAM), or the like. The storage 190 stores, for example, determination condition information 192, change condition information 194, various types of information in the embodiment, programs, and the like. The determination condition information 192 includes, for example, information related to conditions for determining any route when there is a plurality of routes in a traveling direction of the vehicle M. The change condition information 194 includes information related to conditions for performing an override of driving control content (details will be described later). The storage 190 may store map information (for example, the first map information 54 and the second map information 62).

FIG. 3 is a functional configuration diagram of the first control unit 120 and the second control unit 160 according to the embodiment. The first control unit 120 includes, for example, a recognition unit 130, an action plan generation unit 140, and a driving level determination unit 152. The first control unit 120 performs functions based on, for example, artificial intelligence (AI) and a pre-defined model in parallel. For example, a function of “recognizing an intersection” may be realized by executing in parallel recognition of an intersection by deep learning or the like and recognition based on pre-given conditions (such as signals and road signs that can be pattern matched), and by scoring and comprehensively evaluating both.

The recognition unit 130 recognizes a surrounding situation of the vehicle M on the basis of information input from the detection device DD. For example, the recognition unit 130 recognizes states such as a position (a position relative to the vehicle M), a speed (a speed relative to the vehicle M), and an acceleration of an object (for example, another vehicle or a pedestrian) near the vehicle M (within a predetermined distance from the vehicle M). The position of the object, for example, is recognized as a position on absolute coordinates having a representative point of the vehicle M (a center of gravity, a drive shaft center, or the like) as the origin and is used for control. The position of the object may be expressed by a representative point such as the center of gravity or a corner of the object or may be expressed by an area. The “state” of the object may include acceleration or jerk of the object, or “a behavioral state” (for example, whether lane change is performed or to be performed). The recognition unit 130 may recognize a stop line, an obstacle, a red traffic light, a toll gate, and other road events.

The recognition unit 130 recognizes, for example, a lane (a traveling lane) in which the vehicle M is traveling. Here, the recognition unit 130 recognizes, for example, left and right lane markings with reference to the vehicle M (as viewed from the vehicle M) from an image (hereinafter, camera image) captured by the camera 10, and recognizes the travel lane on the basis of the positions of the recognized lane markings. For example, the recognition unit 130 analyzes the camera image, extracts edge points having a large luminance difference from adjacent pixels in the image, connects the edge points, and recognizes lane markings on the image plane. The recognition unit 130 converts the positions of the lane markings based on the position of the representative point of the vehicle M into a vehicle coordinate system, and recognizes a lane demarcated by the left and right lane markings closest to the vehicle M as the travel lane. The recognition unit 130 may recognize an adjacent lane adjacent to the travel lane on the basis of the recognized lane markings. The recognition unit 130 may recognize the travel lane by recognizing targets (roadway boundaries, road boundaries) capable of specifying a lane position including road shoulders, curbs, median strips, guardrails, fences, walls, and the like from an analysis result of the camera image, without being limited to lane markings.

The recognition unit 130 may recognize, for example, lanes around the vehicle M including a travel lane in which the vehicle M travels by referring to map information (for example, the second map information 62) on the basis of the position of the vehicle M detected by the vehicle sensor 40 or the GNSS receiver 51. The recognition unit 130 may recognize lane markings that demarcate the travel lane and may recognize an adjacent lane adjacent to the travel lane and lane markings that demarcate the adjacent lane. The recognition unit 130 may recognize a center line (lane center line) of the travel lane or the adjacent lane from the map information. The recognition unit 130 may recognize lanes and lane markings around the vehicle M by combining information on lanes and lane markings acquired from the camera image and information on lanes and lane markings acquired from the map information.

When recognizing the travel lane, the recognition unit 130 may recognize a position and a posture of the vehicle M with respect to the travel lane. The recognition unit 130 may recognize, for example, a deviation of the reference point of the vehicle M from the lane center and an angle of the direction of advance of the vehicle M relative to a line connecting the lane centers as the relative position and posture of the vehicle M with respect to the traveling lane. Instead, the recognition unit 130 may recognize a position of a reference point of the vehicle M with respect to one side line of the traveling lane (a road lane marking or a road boundary) or the like as the relative position of the vehicle M with respect to the traveling lane.

The recognition unit 130 may recognize a road shape (for example, a straight road, a curved road, an intersection, etc.) in a traveling direction of the vehicle M, whether or not a road shape having a plurality of route candidates exists within a predetermined distance in the traveling direction, and the like. The recognition unit 130 may recognize a road type around the vehicle M by referring to map information. The road type includes, for example, an expressway, an expressway connection road, a main arterial road, a secondary arterial road, a tertiary arterial road, a residential road, and other general roads.

In principle, the action plan generation unit 140 generates a target trajectory in which the vehicle M will automatically travel (without depending on an operation of the driver) in the future such that the vehicle M travels in a recommended lane determined by the recommended lane determination unit 61 and can also cope with surrounding circumstances of the vehicle M. The target trajectory may include, for example, a position element and a speed element. For example, the target trajectory is represented as a sequence of points (trajectory points) that the vehicle M should reach. A trajectory point is a point to be reached by the vehicle M for each predetermined travel distance (for example, about several [m]) in terms of distance along a road. A trajectory point is an example of a position element. Separately from the trajectory points, a target speed and a target acceleration for each predetermined sampling time (for example, about 0.X [sec]) may be generated as a part of the target trajectory. Such a target speed and a target acceleration are an example of a speed element. Alternatively, a trajectory point may be a position to be reached by the vehicle M at the sampling time for each predetermined sampling time. In this case, information on the target speed and the target acceleration is represented by an interval between the trajectory points, and the trajectory point functions as both a position element and a speed element.

The action plan generation unit 140 may set events (functions) of automated driving in generating a target trajectory. The events of automated driving include a constant-speed travel event, a low-speed following travel event, a lane change event, a branching event, a merging event, and a takeover event. The action plan generation unit 140 generates a target trajectory according to a triggered event. The action plan generation unit 140 generates a target trajectory so that driving control corresponding to the content determined by the driving level determination unit 152 can be executed.

The determination unit 150 includes, for example, an acquisition unit 151, a driving level determination unit 152, a route determination unit 153, and a processing unit 154. The acquisition unit 151 is an example of a "manual operation acquisition unit". The action plan generation unit 140, the driving level determination unit 152, the processing unit 154, and the second control unit 160 are an example of a "travel control unit".

The acquisition unit 151 acquires a recognition result recognized by the recognition unit 130, a detection result of the vehicle sensor 40, and the like. The acquisition unit 151 acquires, for example, operation content of an occupant of the vehicle M from the HMI 30 or the like. The operation content includes, for example, information related to control of the vehicle M such as a switching operation of a driving level described later, and determination conditions of a route during traveling. The operation content may be, for example, information related to a destination input via the navigation device 50. In this case, the acquisition unit 151 may acquire information on whether or not a destination has been input by an occupant, and when a destination has been input, may acquire information on a specific place of the destination. The acquisition unit 151 acquires manual operation information from the manual operation unit 80. The acquisition unit 151 may acquire an image in which an occupant has been captured from the driver monitor camera 70.

The driving level determination unit 152 determines a driving level of the vehicle M to any one of a plurality of driving levels (in other words, a plurality of levels with different degrees of automation) in which tasks imposed on a driver are different, on the basis of information acquired by the acquisition unit 151 and the like.

The driving level of the vehicle M includes a plurality of levels including, for example, a first driving level, a second driving level, and a third driving level. The first driving level has a higher control state of the vehicle M, that is, a degree of automation (control degree) of driving control of the vehicle M, than the second driving level. In other words, the first driving level has lighter tasks imposed on an occupant (driver) than the second driving level. The second driving level has a higher control state of the vehicle M, that is, a degree of automation (control degree) of driving control of the vehicle M, than the third driving level. In other words, the second driving level has lighter tasks imposed on an occupant (driver) than the third driving level. The first driving level includes automated driving, the second driving level includes semi-automated driving, and the third driving level includes manual driving. When the first driving level is control related to automated driving and switching is made from the first driving level to the third driving level, the responsibility of the automated driving control device 100 is to end control related to automated driving and shift to manual driving. When the second driving level is control related to semi-automated driving and switching is made from the second driving level to the third driving level, the responsibility of the automated driving control device 100 is to end control related to semi-automated driving and shift to manual driving. Hereinafter, the first driving level, the second driving level, and the third driving level will be specifically described. The driving level of the vehicle M may include, for example, four or more driving levels.

In the first driving level, neither a manual operation related to acceleration/deceleration nor steering of the vehicle M (that is, a manual operation on the acceleration/deceleration operator and the steering operator) is imposed on an occupant. That is, in the first driving level, both acceleration/deceleration and steering of the vehicle M are automatically controlled by the first control unit 120 and the second control unit 160. In the first driving level, neither monitoring of surroundings of the vehicle M nor gripping of a steering wheel (hereinafter referred to as "steering gripping") may be imposed on an occupant. In the first driving level, there may be a restriction that a task of monitoring surroundings of the vehicle M (hereinafter, surrounding monitoring) is imposed on an occupant, but a task of steering wheel gripping is not imposed. For example, in the first driving level, a lane change (ALC) or a right/left turn control, a lane keeping control (LKAS), or the like of the vehicle M based on route setting to a destination by the navigation device 50 or the like is performed by a determination on the vehicle system 1 side without accepting a lane change instruction from an occupant (without accepting a driving operation by an occupant). In the first driving level, even when a destination is not set, automated driving of traveling along a road (route) may be performed on the basis of a predetermined route determination condition.

In the second driving level, a manual operation related to one of acceleration/deceleration and steering of the vehicle M (that is, a manual operation on one of the acceleration/deceleration operator and the steering operator) is not imposed on an occupant, and a manual operation related to the other of acceleration/deceleration and steering (that is, a manual operation on the other of the acceleration/deceleration operator and the steering operator) is imposed on the occupant. That is, in the second driving level, automatic control by the first control unit 120 and the second control unit 160 is performed for that of acceleration/deceleration and steering of the vehicle M for which a manual operation is not imposed on an occupant, and automatic control by the first control unit 120 and the second control unit 160 is not performed for that of acceleration/deceleration and steering for which a manual operation is imposed on the occupant. Specifically, the second driving level may be subdivided into two levels: an automatic steering level in which steering of a vehicle is automatically controlled and acceleration/deceleration is manually controlled by manual operation of an occupant, and an automatic acceleration/deceleration level in which steering of a vehicle is automatically controlled and acceleration/deceleration is manually controlled by manual operation of an occupant.

In the third driving level, a manual operation related to both acceleration/deceleration and steering of the vehicle M (that is, a manual operation on both the acceleration/deceleration operator and the steering operator) is imposed on an occupant. That is, in the third driving level, neither acceleration/deceleration nor steering of the vehicle M is automatically controlled by the first control unit 120 and the second control unit 160. In the third driving level, tasks of surrounding monitoring and steering gripping may be imposed on an occupant.

The driving level determination unit 152 determines, in principle, a driving level on the basis of an instruction from an occupant. For example, the driving level determination unit 152 determines a driving level to one designated by an occupant via the HMI 30 (for example, a driving switching switch). On the other hand, during execution of the first driving level (that is, during automatic control of both acceleration/deceleration and steering of the vehicle M), when an occupant performs a manual operation on the manual operation unit 80, manual operation information is acquired by the acquisition unit 151, and the manual operation information satisfies a predetermined condition, the driving level determination unit 152 changes content of automatic control in the first driving level, or switches the driving level from the first driving level to the second driving level or the third driving level. That is, when an occupant performs a manual operation on the manual operation unit 80, content of driving control by the first control unit 120 and the second control unit 160 is changed (that is, overridden) according to the content of the manual operation. Details of the override by the driving level determination unit 152 will be described later.

The driving level determination unit 152 may change to a driving level with heavier tasks when a task related to the determined driving level is not executed by a driver. For example, during execution of the first driving level, when an occupant is in a posture in which the occupant cannot shift to manual driving in response to a request from the system (for example, when the occupant continues to look aside outside an allowable area, or when a symptom that makes driving difficult is detected), the driving level determination unit 152 may cause the HMI control unit 180 to execute control for prompting the occupant to shift to manual driving, which is the third driving level, using the HMI 30. When a predetermined time has elapsed since the HMI control unit 180 executed control for prompting a shift to manual driving and the occupant does not respond, or when it is estimated that the occupant is not in a state to perform manual driving, the driving level determination unit 152 may perform control such as gradually decelerating while bringing the vehicle M toward a target position (for example, a road shoulder) and stopping automated driving. After stopping automated driving, the vehicle M is in a state of the third driving level, and it becomes possible to start the vehicle M by a manual operation of an occupant.

The route determination unit 153 determines a route of the vehicle M according to a situation of the vehicle M on the basis of information acquired by the acquisition unit 151 and information determined by the driving level determination unit 152. For example, when the driving level determined by the driving level determination unit 152 is the first driving level or the second driving level, the route determination unit 153 determines a travel mode according to a situation of the vehicle M. Details of a function of the route determination unit 153 will be described later.

The processing unit 154 executes various types of processing on the basis of the driving level determined by the driving level determination unit 152 and the route determined by the route determination unit 153. For example, the processing unit 154 performs various types of processing for changing to the driving level determined by the driving level determination unit 152 and maintaining a current driving level. For example, the processing unit 154 causes the action plan generation unit 140 to generate a target trajectory (position element and speed element) for causing the vehicle M to travel according to the driving level. For example, when the driving level is the first driving level, the processing unit 154 may cause the action plan generation unit 140 to generate a target trajectory including both a position element and a speed element. On the other hand, when the driving level is the second driving level, the processing unit 154 may cause the action plan generation unit 140 to generate a target trajectory including only one corresponding to a target (steering or acceleration/deceleration) to be automatically controlled in the second driving level among the position element and the speed element. Specifically, when the driving level is the automatic steering level, the processing unit 154 may cause the action plan generation unit 140 to generate a target trajectory including a position element and not including a speed element. When the driving level is the automatic acceleration/deceleration level, the processing unit 154 may cause the action plan generation unit 140 to generate a target trajectory including a speed element and not including a position element. When the driving level is the third driving level, the processing unit 154 may not cause the action plan generation unit 140 to generate a target trajectory.

Even when the driving level is the second driving level, the processing unit 154 may cause the action plan generation unit 140 to generate a target trajectory including both a position element and a speed element. For example, a speed control unit 164 described later may be configured not to control the traveling driving force output device 200 and the brake device 210 when the driving level is the automatic steering level. A steering control unit 166 described later may be configured not to control the steering device 220 when the driving level is the automatic acceleration/deceleration level.

The action plan generation unit 140 generates a target trajectory for causing the vehicle M to travel on the basis of information determined by the determination unit 150, a recognition result of the recognition unit 130, and the like.

The second control unit 160 controls the traveling driving force output device 200, the brake device 210, and the steering device 220 so that the vehicle M passes through the target trajectory generated by the action plan generation unit 140 at the scheduled time. Specifically, when the first driving level is being executed, the second control unit 160 may control all of the traveling driving force output device 200, the brake device 210, and the steering device 220. When the automatic steering level of the second driving level is being executed, the second control unit 160 may control the steering device 220 and may not control the traveling driving force output device 200 and the brake device 210. When the automatic acceleration/deceleration level of the second driving level is being executed, the second control unit 160 may control the traveling driving force output device 200 and the brake device 210 and may not control the steering device 220. When the third driving level is being executed, the second control unit 160 may not control any of the traveling driving force output device 200, the brake device 210, and the steering device 220.

The second control unit 160 includes, for example, a target trajectory acquirer 162, a speed control unit 164, and a steering control unit 166. The target trajectory acquirer 162 acquires information on the target trajectory (trajectory points) generated by the action plan generation unit 140 and stores the information on the target trajectory in a memory (not shown). The speed control unit 164 controls the traveling driving force output device 200 or the brake device 210 on the basis of the speed element associated with the target trajectory stored in the memory. Control by the speed control unit 164 is executed when the first driving level or the automatic acceleration/deceleration level of the second driving level is being executed. The steering control unit 166 controls the steering device 220 according to a degree of bending calculable from a position element of the target trajectory stored in the memory. Control by the steering control unit 166 is executed in the first driving level or the automatic steering level of the second driving level. The processing of the speed control unit 164 and the steering control unit 166 is realized, for example, by a combination of feed-forward control and feedback control. For example, the steering control unit 166 performs control in combination of feed-forward control based on a curvature of a road in front of the vehicle M and feedback control based on a separation from the target trajectory.

Referring back to FIG. 1, the HMI control unit 180 uses the HMI 30 to notify the occupant of predetermined information. The predetermined information includes, for example, information on the traveling of the vehicle M, such as information on the state of the vehicle M and information on driving control. For example, the information related to the state of the vehicle M includes a speed of the vehicle M, a rotation frequency of the engine, a shift position, and the like. Information related to driving control includes, for example, an inquiry as to whether or not to perform a lane change, presence or absence of execution of a driving level, information related to a change in driving level, information imposed on an occupant necessary to switch a driving level (task request information for an occupant), information related to a situation of driving control (for example, content of a driving level being executed), and the like. Information related to driving control may include information related to a route determined by the route determination unit 153 and information related to a route (road) selected by a determination mode being executed. The predetermined information may include information not related to driving control of the vehicle M, such as a TV program or content (for example, a movie) stored in a storage medium such as a DVD. The predetermined information may include, for example, a current position or a destination of the vehicle M and information on an amount of fuel remaining.

For example, the HMI control unit 180 may generate an image including the aforementioned predetermined information and display the generated image on a display device of the HMI 30 or may generate sound indicating the predetermined information and output the generated sound from a speaker of the HMI 30. The HMI control unit 180 may output information received by the HMI 30 to the communication device 20, the navigation device 50, the first control unit 120, and the like.

The traveling driving force output device 200 outputs a traveling driving force (torque) to the driving wheels so that the vehicle travels. The traveling driving force output device 200 includes, for example, a combination of an internal combustion engine, an electric motor, a transmission, and an electronic control unit (ECU) that controls these. The ECU controls the above configuration according to information input from the second control unit 160 or information input from the manual operation unit 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to information input from the second control unit 160 or information input from the manual operation unit 80 and causes brake torque according to a braking operation to be output to each wheel. The brake device 210 may include, as a backup, a mechanism that transmits hydraulic pressure generated by an operation of the brake pedal 81-3 to the cylinder via a master cylinder. The brake device 210 is not limited to the above-described configuration and may be an electronically controlled hydraulic brake device configured to control an actuator in accordance with information input from the second control unit 160 and transfer the hydraulic pressure of the master cylinder to the cylinder.

The steering device 220, for example, includes a steering ECU and an electric motor. The electric motor, for example, applies a force to a rack and pinion mechanism to change the direction of the steered wheels. The steering ECU drives the electric motor according to information input from the second control unit 160 or information input from the manual operation unit 80 to change the direction of the steered wheels.

### Route Determination Unit

Next, details of a function of the route determination unit 153 will be described. In the following description, unless otherwise specified, a function of the route determination unit 153 during execution of the first driving level (automated driving) will be mainly described. Although detailed description is omitted, even during execution of the second driving level (semi-automated driving), the route determination unit 153 may exhibit a function similar to the following description. The route determination unit 153 uses any one of a plurality of predetermined determination modes to determine a route of the vehicle M on the basis of a surrounding situation such as a road shape in a traveling direction of the vehicle M recognized by the recognition unit 130 and an instruction from an occupant of the vehicle M acquired by the acquisition unit 151.

Here, the plurality of determination modes include, for example, a first mode for determining a route toward a destination direction among a plurality of route candidates when a road shape having a plurality of route candidates exists in a traveling direction of the vehicle M and a destination of the vehicle M is set, and a second mode for determining a route on which the vehicle M travels on the basis of a predetermined road standard or the like among a plurality of route candidates when a road shape having a plurality of route candidates exists and a destination of the vehicle M is not set. A road shape having a plurality of route candidates is, for example, an intersecting road in which a plurality of lanes including a travel lane intersect, and is a road shape in which a route other than straight ahead (for example, a route requiring a right or left turn) exists, such as an intersection such as a crossroads, a T-junction, or a Y-junction. A road shape having a plurality of route candidates may include a roundabout.

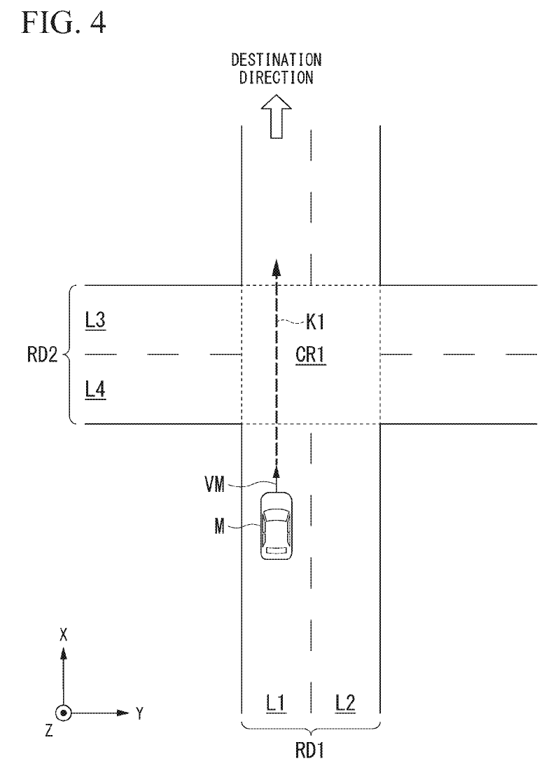

FIG. 4 is a diagram for explaining an example of route determination and target trajectory generation in a case of the first mode. In the example of FIG. 4, an intersecting road (more specifically, a crossroads) where a road RD1 and a road RD2 intersect at an intersection CR1 is shown. On the road RD1, there are a lane L1 that can be traveled along in an X-axis direction in the drawing and a lane L2 that is an opposite lane of the lane L1, and on the road RD2, there are a lane L3 that can be traveled along in a Y-axis direction in the drawing and a lane L4 that is an opposite lane of the lane L3. In FIG. 4, it is assumed that the vehicle M is traveling on the lane L1 toward the intersection CR1 at a speed VM (that is, a road shape having a plurality of route candidates exists within a predetermined distance in a traveling direction of the vehicle M). In the example of FIG. 4, it is assumed that driving control by the first driving level is being executed for the vehicle M.

In the example of FIG. 4, when a destination has already been set by an occupant of the vehicle M, the route determination unit 153 determines a route toward the destination direction at the intersection CR1. In the example of FIG. 4, a route that goes straight through the intersection CR1 toward the destination direction (continues traveling on the lane L1) is determined. Then, the action plan generation unit 140 generates a target trajectory K1 so that the vehicle M travels according to the determined route.

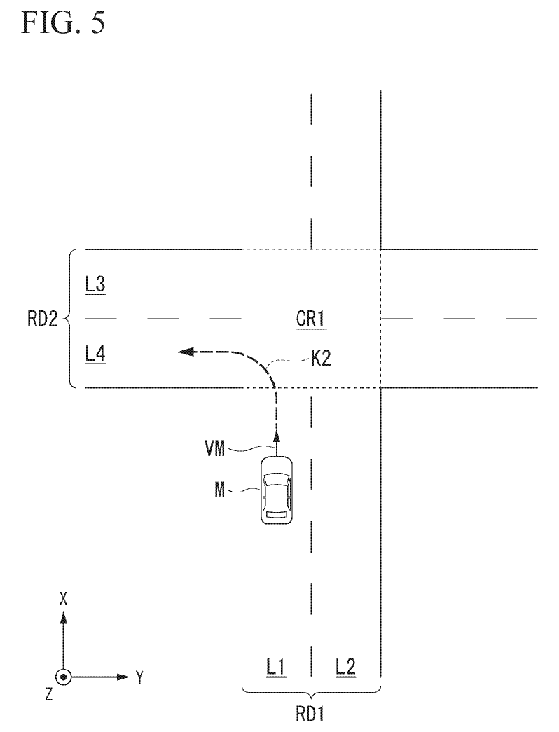

FIG. 5 is a diagram for explaining an example of route determination and target trajectory generation in a case of the second mode. In the example of FIG. 5, the vehicle M is traveling on a road having a road shape similar to FIG. 4. When a destination of the vehicle M is not set, the route determination unit 153 determines a road on which the vehicle M travels beyond the intersection CR1 on the basis of the determination condition information 192 set in advance. The determination condition information 192 includes, for example, first information 192A related to a priority based on a road standard, second information 192B related to a road rank based on a comparison between a road including a travel lane and an intersecting road, and the like.

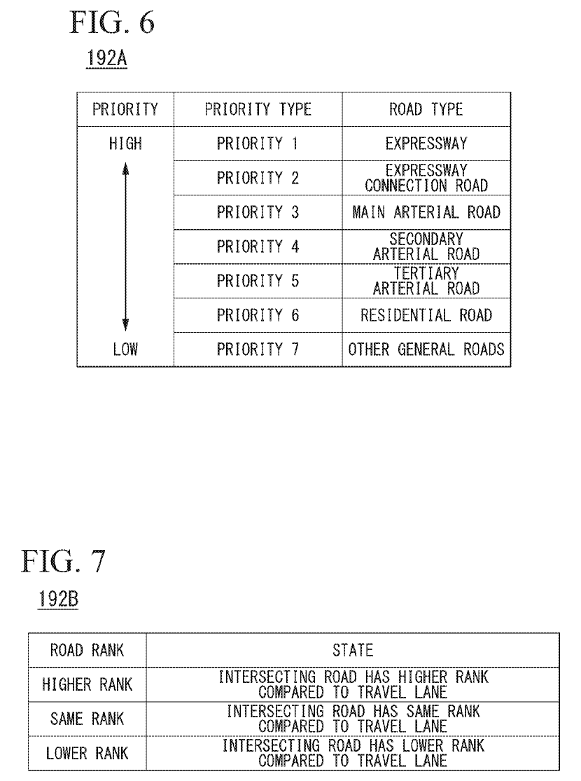

FIG. 6 is a diagram showing an example of the first information 192A. In the first information 192A shown in FIG. 6, for example, a priority, a priority type, and a road type are associated with each other. The road type is information related to a road standard, and is information that can be acquired, for example, from map information (the first map information 54, the second map information 62). In the example of FIG. 6, priorities 1 to 7 are assigned in descending order of priority, "expressway" is associated with priority 1 as a road type, "expressway connection road" is associated with priority 2, "main arterial road" is associated with priority 3, "secondary arterial road" is associated with priority 4, "tertiary arterial road" is associated with priority 5, "residential road" is associated with priority 6, and "other general roads" is associated with priority 7. The number of priorities and road types assigned to each priority in the embodiment are not limited to the example of FIG. 6.

FIG. 7 is a diagram showing an example of the second information 192B. In the second information 192B shown in FIG. 7, for example, a road rank and a state of a travel lane and an intersecting road are associated with each other. For example, a rank "higher" indicates that an intersecting road has a higher rank compared to a travel lane (or a road including a travel lane), a rank "same" indicates that an intersecting road has the same rank compared to a travel lane, and a rank "lower" indicates that an intersecting road has a lower rank compared to a travel lane. This road rank may be determined, for example, according to a priority included in the first information 192A. For example, when a priority type of a road including a travel lane (for example, road RD1) is "priority 4", if a priority type of an intersecting road (for example, road RD2) is "priority 3", "priority 2", or "priority 1", a road rank of the intersecting road is "higher", if the priority type is "priority 4", a road rank of the intersecting road is "same", and if the priority type is "priority 5", "priority 6", or "priority 7", a road rank of the intersecting road is "lower". The road rank may be set based on other criteria. The determination condition information 192 may not include the second information 192B.

When determining a route in the second mode, the route determination unit 153 uses at least one of the first information 192A and the second information 192B to determine a route of the vehicle M when passing through the intersection CR1. For example, the route determination unit 153 acquires a road type of roads RD1 and RD2 connected to the intersection CR1 on the basis of position information of the vehicle M, and acquires a priority associated with the acquired road type. Then, the route determination unit 153 determines a route (traveling direction) of the vehicle M on the basis of the acquired priority. The route determination unit 153 may use the second information 192B to acquire a road rank according to a priority type of each of a road including a travel lane and an intersecting road and may determine a route of the vehicle M on the basis of the acquired road rank.

For example, the route determination unit 153 determines a route so as to cause the vehicle M to travel on a road with a higher priority. For example, when a priority type of a travel lane is "priority 4", a priority type of a road rank "higher" of an intersecting road is "priority 1", "priority 2", or "priority 3", a priority type of "same" is "priority 4", and a priority type of "lower" is "priority 5", "priority 6", or "priority 7". For example, when a lane (a lane other than a travel lane) of the road RD2 is lower than or the same as the travel lane L1, the route determination unit 153 determines the current lane L1 as a route, and when a lane of the road RD2 is higher, the route determination unit 153 determines a lane included in the road RD2 as a route. When a plurality of lanes is included in the road RD2, the route determination unit 153 may select a lane in a predetermined direction as viewed from the vehicle M. The route determination unit 153 may determine a lane that does not pass through another lane (for example, an opposite lane) as a route of the vehicle M. Thereby, the vehicle M can be moved in a direction with less risk and higher safety.

In the example of FIG. 5, a road rank of the road RD2 is higher than the road RD1. Therefore, the route determination unit 153 determines a route of the vehicle M as the road RD2 and further determines the lane L4 as a route because the lane L4 among the lanes L3 and L4 included in the road RD2 does not pass through the lane L2, which is an opposite lane of the lane L1. The action plan generation unit 140 generates a target trajectory K2 for turning left at the intersection CR1 and traveling on the lane L4, outputs the generated target trajectory K2 to the second control unit 160 and causes driving control to be executed. Thereby, even when a destination is not set in a road shape where an intersecting road or the like exists, driving control of the first driving level can be continued. By determining a route on the basis of a road standard, a determination condition becomes clear, so that a sense of discomfort of an occupant can be reduced, and since traveling along a road can be continued, candidates for a destination can be expanded.

The route determination unit 153 may perform route determination within a predetermined time (for example, within about 1.0 [sec]) after returning when returning to driving control of the first driving level or the second driving level again after switching from the first driving level (automated driving) or the second driving level (semi-automated driving) to the third driving level (manual driving) (after being overridden). Thereby, even when manual driving is temporarily performed, a route is determined immediately after returning, and driving control of the first driving level or the second driving level is executed, so that more appropriate driving control can be realized.

When performing route determination by the second mode, the route determination unit 153 may perform route determination on the basis of a road shape instead of (or in addition to) the determination condition information 192 described above. For example, when a road shape having a plurality of route candidates in a traveling direction of the vehicle M is a T-junction, it is impossible to go straight, and a right or left turn is required. Therefore, the route determination unit 153 may determine a route of either right or left turn (for example, left turn) regardless of a road rank or priority.

### Driving Level Determination Unit

Next, details of an override of driving control content by the driving level determination unit 152 will be described. In the following description, unless otherwise specified, it is assumed that the first driving level (automated driving) is being executed. When manual operation information related to one of acceleration/deceleration and steering is acquired by the acquisition unit 151 and manual operation information related to the other of acceleration/deceleration and steering is not acquired by the acquisition unit 151, the driving level determination unit 152 overrides content of driving control by the first control unit 120 and the second control unit 160 on the basis of a predetermined condition.

For example, when manual operation conditions satisfy a first condition, the driving level determination unit 152 continues both automatic control related to acceleration/deceleration and automatic control related to steering by continuing the first driving level. At this time, the driving level determination unit 152 changes content of driving control by the first control unit 120 and the second control unit 160 according to the manual operation information satisfying the first condition. For example, the driving level determination unit 152 may cause the action plan generation unit 140 to set an automated driving event (for example, a lane change event or the like) according to the manual operation information satisfying the first condition through the processing unit 154 and may cause a target trajectory based on this event to be generated. Alternatively, the driving level determination unit 152 may cause the action plan generation unit 140 to generate a target trajectory (speed element) for accelerating or decelerating the vehicle M by a predetermined value (for example, 5 [km/h]) through the processing unit 154. However, specific change content of driving control of the first driving level when manual operation information is acquired can be appropriately changed.

Here, the first condition may be a condition determined in advance and stored in the storage 190 as a part of the change condition information 194. The first condition is a condition related to the operation intensity included in manual operation information. The operation intensity is, for example, a parameter indicating intensity of a manual operation performed by an occupant on the driving operators 81-1 to 81-N, and may be an operation amount or an operation speed of the driving operators 81-1 to 81-N. For example, in manual operation information related to steering, the operation intensity may be a steering operation amount and a steering speed. The steering operation amount may be a steering angle, a steering torque, a combination thereof, or the like. In manual operation information related to acceleration/deceleration, the operation intensity may be an operation amount of an acceleration/deceleration operator and an operation speed of the acceleration/deceleration operator.

When manual operation information related to steering is acquired, the first condition may be, for example, that both a steering operation amount and a steering speed are less than a threshold. Specifically, the first condition may be that a steering operation amount is less than a first threshold and a steering speed is less than a second threshold. The first condition may include, in addition to both a steering operation amount and a steering speed being less than a threshold, that the steering operation amount and/or the steering speed is equal to or greater than a predetermined lower limit value (first lower limit value). Here, the first lower limit value is a value smaller than the first threshold or the second threshold. Thereby, when an occupant unintentionally touches a steering operator, a possibility that content of driving control is overridden contrary to an occupant's intention can be reduced.

When manual operation information related to acceleration/deceleration is acquired, the first condition may be that both an operation amount of an acceleration/deceleration operator and an operation speed of the acceleration/deceleration operator are less than a threshold. Specifically, the first condition may be that an operation amount of an acceleration/deceleration operator is less than a third threshold and an operation speed of the acceleration/deceleration operator is less than a fourth threshold. The first condition may include, in addition to both an operation amount of an acceleration/deceleration operator and an operation speed of the acceleration/deceleration operator being less than a threshold, that the operation amount of the acceleration/deceleration operator and/or the operation speed of the acceleration/deceleration operator is equal to or greater than a predetermined lower limit value (second lower limit value). Here, the second lower limit value is a value smaller than the third threshold or the fourth threshold. Thereby, when an occupant unintentionally touches an acceleration/deceleration operator, a possibility that content of driving control is overridden contrary to an occupant's intention can be reduced.

When manual operation conditions satisfy a second condition, the driving level determination unit 152 cancels one of automatic control related to acceleration/deceleration and automatic control related to steering and continues the other by shifting from the first driving level to the second driving level. Specifically, automatic control related to that of acceleration/deceleration and steering for which manual operation information has been acquired is canceled, and automatic control related to that of acceleration/deceleration and steering for which manual operation information has not been acquired is continued. For example, when manual operation information related to steering is acquired by the acquisition unit 151, the driving level determination unit 152 cancels automatic control related to steering and continues automatic control related to acceleration/deceleration by shifting to the automatic acceleration/deceleration level. When manual operation information related to acceleration/deceleration is acquired by the acquisition unit 151, the driving level determination unit 152 cancels automatic control related to acceleration/deceleration and continues automatic control related to steering by shifting to the automatic steering level.

The second condition may be a condition determined in advance and stored in the storage 190 as a part of the change condition information 194. The second condition is a condition related to the operation intensity included in manual operation information. The second condition is a condition in which an operation intensity is greater than in the first condition. In other words, the second condition is a condition that requires an operation intensity greater than the first condition.

When manual operation information related to steering is acquired, the second condition may be, for example, that one of a steering operation amount and a steering speed is equal to or greater than a threshold, and the other of the steering operation amount and the steering speed is less than a threshold. Specifically, the second condition may be that one of that a steering operation amount is less than a first threshold and that a steering speed is less than a second threshold is satisfied and the other is not satisfied. More specifically, the second condition may be that a steering operation amount is equal to or greater than a first threshold and a steering speed is less than a second threshold.

When manual operation information related to acceleration/deceleration is acquired, the second condition may be that one of an operation amount of an acceleration/deceleration operator and an operation speed of the acceleration/deceleration operator is equal to or greater than a threshold, and the other of the operation amount of the acceleration/deceleration operator and the operation speed of the acceleration/deceleration operator is less than a threshold. Specifically, the second condition may be that one of that an operation amount of an acceleration/deceleration operator is less than a third threshold and that an operation speed of the acceleration/deceleration operator is less than a fourth threshold is satisfied and the other is not satisfied.

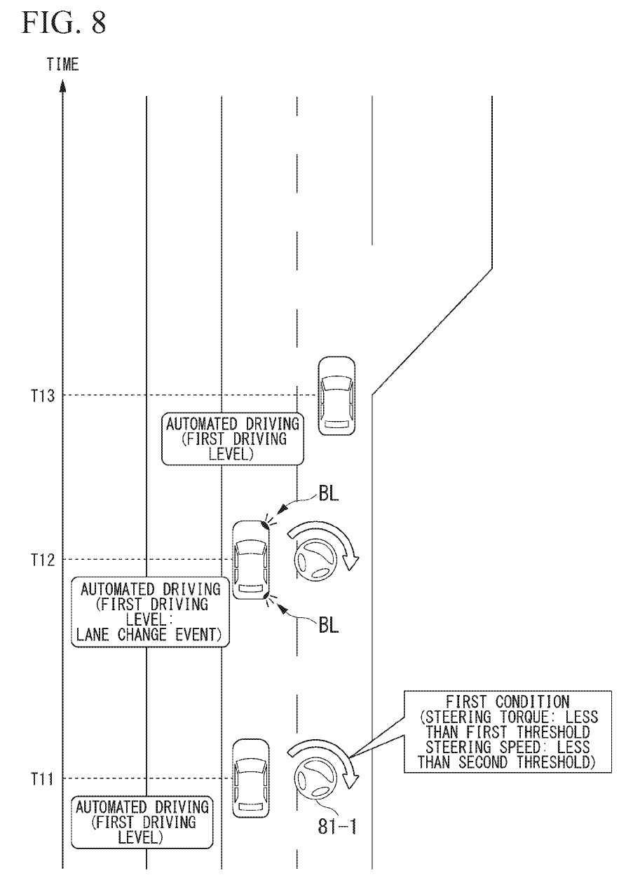

FIG. 8 is a diagram for explaining an example of driving control in a case where manual operation information related to steering satisfies a first condition. A first condition in the example of FIG. 8 is that a steering torque as a steering operation amount is less than a first threshold and a steering speed is less than a second threshold. In the example of FIG. 8, at time T11, an occupant manually operates the steering wheel 81-1, and manual operation information satisfying the first condition is acquired. By acquiring manual operation information satisfying the first condition, the driving level determination unit 152 causes the action plan generation unit 140 to set a lane change event while continuing the first driving level. That is, the driving level determination unit 152 regards manual operation information related to steering satisfying the first condition as an intention to change lanes by an occupant and implements lane change support.

Thereby, at time T12 after time T11, a lane change of the vehicle M is automatically executed by the first control unit 120 and the second control unit 160. At this time, a turn signal (direction indicator) BL provided in the vehicle M may be automatically turned on or blinked by the automated driving control device 100. At time T13 after time T12, the lane change of the vehicle M is completed, and thereafter, normal automated driving (that is, automated driving without an override based on manual operation information) based on the first driving level is executed.

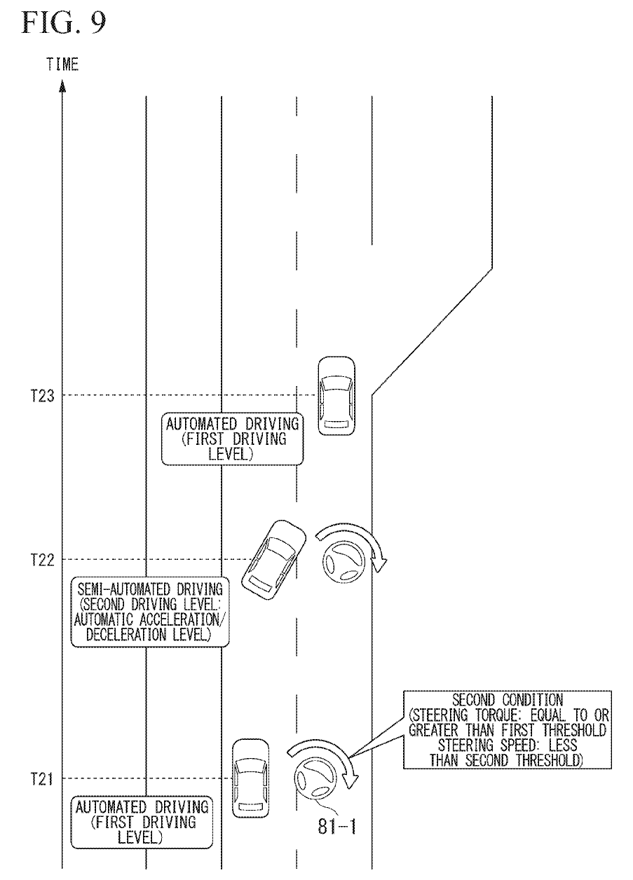

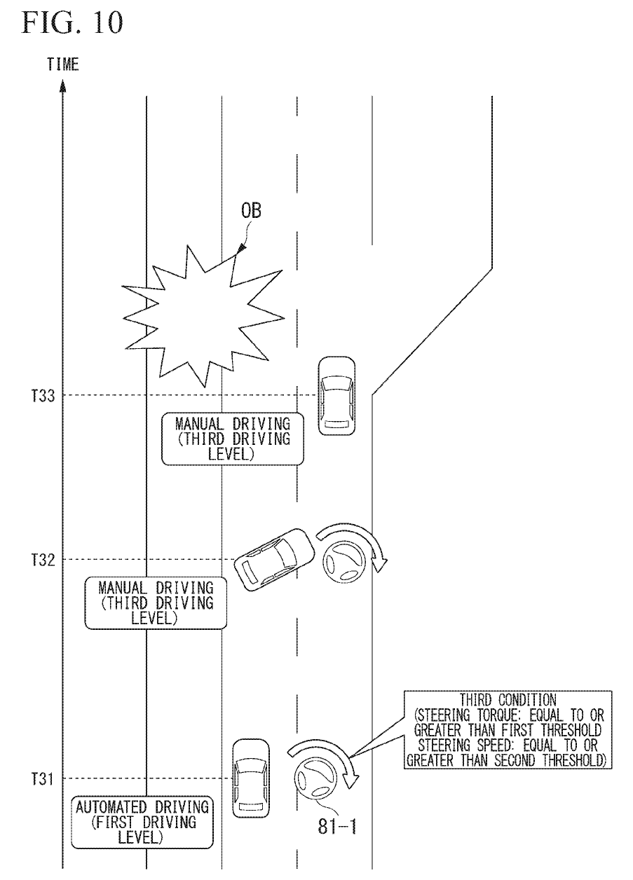

FIG. 9 is a diagram for explaining an example of driving control in a case where manual operation information related to steering satisfies a second condition. A second condition in the example of FIG. 9 is that a steering torque as a steering operation amount is equal to or greater than a first threshold and a steering speed is less than a second threshold. In the example of FIG. 9, at time T21, an occupant manually operates the steering wheel 81-1, and manual operation information satisfying the second condition is acquired. By acquiring manual operation information satisfying the second condition, the driving level determination unit 152 switches a driving level from the first driving level to the automatic acceleration/deceleration level of the second driving level. That is, the driving level determination unit 152 regards manual operation information related to steering satisfying the second condition as an intention to start manual steering by an occupant and temporarily stops steering support.

Thereby, at time T22 after time T21, steering of the vehicle M is manually controlled by an occupant, and acceleration/deceleration of the vehicle M is automatically controlled by the first control unit 120 and the second control unit 160. At this time, a turn signal (direction indicator) BL provided in the vehicle M may not be automatically turned on or blinked by the automated driving control device 100. In the example of FIG. 9, when the operation intensity (for example, steering torque) of a steering operator by an occupant falls below a predetermined reference value (first reference value), the driving level determination unit 152 returns a driving level from the second driving level (automatic acceleration/deceleration level) to the first driving level. Thereby, at and after time T23 after time T22, automated driving of the vehicle M based on the first driving level is resumed. That is, the driving level determination unit 152 regards that the operation intensity of a steering operator has fallen below the first reference value as an intention to end manual steering by an occupant and resumes steering support.

As described above, in the embodiment, changing of content of automatic control in automated driving (first driving level) and switching of a driving level from automated driving to semi-automated driving (second driving level) are selectively used according to intensity of a manual operation by an occupant. Thereby, driving control according to an occupant's intention can be executed.

By making a determination based on magnitude of a plurality of parameters (steering operation amount and steering speed) for each of the first condition and the second condition related to steering, driving control more in line with an occupant's intention can be executed more accurately compared to a case of making a determination based on magnitude of one parameter. In particular, by making the second condition that a steering operation amount is equal to or greater than a threshold and a steering speed is less than a threshold, driving control that more reflects an occupant's intention can be executed. That is, when a steering speed is small, it is presumed that it is not sudden steering such as obstacle avoidance or an operation that can change a road attribute such as a right or left turn, so by canceling only automatic control related to steering and continuing semi-automated driving in such a case, driving control that more reflects an occupant's intention can be executed.

By making a determination based on magnitude of a plurality of parameters (operation amount of an acceleration/deceleration operator and operation speed of the acceleration/deceleration operator) for each of the first condition and the second condition related to acceleration/deceleration, driving control more in line with an occupant's intention can be executed more accurately compared to a case of making a determination based on magnitude of one parameter.

When manual operation conditions satisfy a third condition, the driving level determination unit 152 may cancel both automatic control related to acceleration/deceleration and automatic control related to steering by shifting from the first driving level to the third driving level. The third condition may be a condition determined in advance and stored in the storage 190 as a part of the change condition information 194. The third condition is a condition related to the operation intensity included in manual operation information. The third condition is a condition in which an operation intensity is greater than the second condition. In other words, the third condition is a condition that requires an operation intensity greater than the second condition.

When manual operation information related to steering is acquired, the third condition may be, for example, that both a steering operation amount and a steering speed are equal to or greater than a threshold. Specifically, the third condition may be that a steering operation amount is equal to or greater than a first threshold and a steering speed is equal to or greater than a second threshold. When manual operation information related to acceleration/deceleration is acquired, the third condition may be that both an operation amount of an acceleration/deceleration operator and an operation speed of the acceleration/deceleration operator are equal to or greater than a threshold. Specifically, the third condition may be that an operation amount of an acceleration/deceleration operator is equal to or greater than a third threshold and an operation speed of the acceleration/deceleration operator is equal to or greater than a fourth threshold.

FIG. 10 is a diagram for explaining an example of driving control in a case where manual operation information related to steering satisfies a third condition. A third condition in the example of FIG. 10 is that a steering torque as a steering operation amount is equal to or greater than a first threshold and a steering speed is equal to or greater than a second threshold. In the example of FIG. 10, at time T31, an occupant manually operates the steering wheel 81-1 to urgently avoid an obstacle OB (for example, an accident vehicle or the like), and manual operation information satisfying the third condition is acquired. By acquiring manual operation information satisfying the third condition, the driving level determination unit 152 switches a driving level from the first driving level to the third driving level. That is, the driving level determination unit 152 regards manual operation information related to steering satisfying the third condition as an urgent avoidance action by an occupant and stops automated driving.

Thereby, at time T32 after time T31, both steering and acceleration/deceleration of the vehicle M are manually controlled by an occupant. In the example of FIG. 10, at time T33 after time T32, even when an urgent avoidance action by an occupant ends, the driving level determination unit 152 continues the third driving level. When shifting from the first driving level to the third driving level, the driving level determination unit 152 may wait for an instruction to return a driving level to the first driving level, for example, by an occupant operating the HMI 30. For example, the driving level determination unit 152 may cause the HMI 30 to display, through the HMI control unit 180, a reception display (for example, a virtual button or the like) for accepting an instruction to return from the third driving level to the first driving level. Then, when the instruction is acquired by the acquisition unit 151 by an occupant operating the reception display, the driving level determination unit 152 may return a driving level from the third driving level to the first driving level.

By performing driving control based on the third condition as described above, when an operation intensity of a manual operation is large, automatic control can be canceled and a shift to manual control can be made. By making a determination based on magnitude of a plurality of parameters (steering operation amount and steering speed) for the third condition related to steering, whether or not cancellation of automatic control is necessary can be determined more accurately in line with an occupant's intention compared to a case of making a determination based on magnitude of one parameter. By making a determination based on magnitude of a plurality of parameters (operation amount of an acceleration/deceleration operator and operation speed of the acceleration/deceleration operator) for the third condition related to acceleration/deceleration, whether or not cancellation of automatic control is necessary can be determined more accurately in line with an occupant's intention compared to a case of making a determination based on magnitude of one parameter.

### Processing Flow

Hereinafter, processing executed by the automated driving control device 100 of the embodiment will be described. Hereinafter, among processing executed by the automated driving control device 100, processing when a manual operation related to steering or acceleration/deceleration is performed during execution of automated driving will be mainly described. Processing shown below may be repeatedly executed every time a manual operation related to steering or acceleration/deceleration is performed during execution of automated driving.

### When a Manual Operation Related to Steering is Performed During Execution of Automated Driving

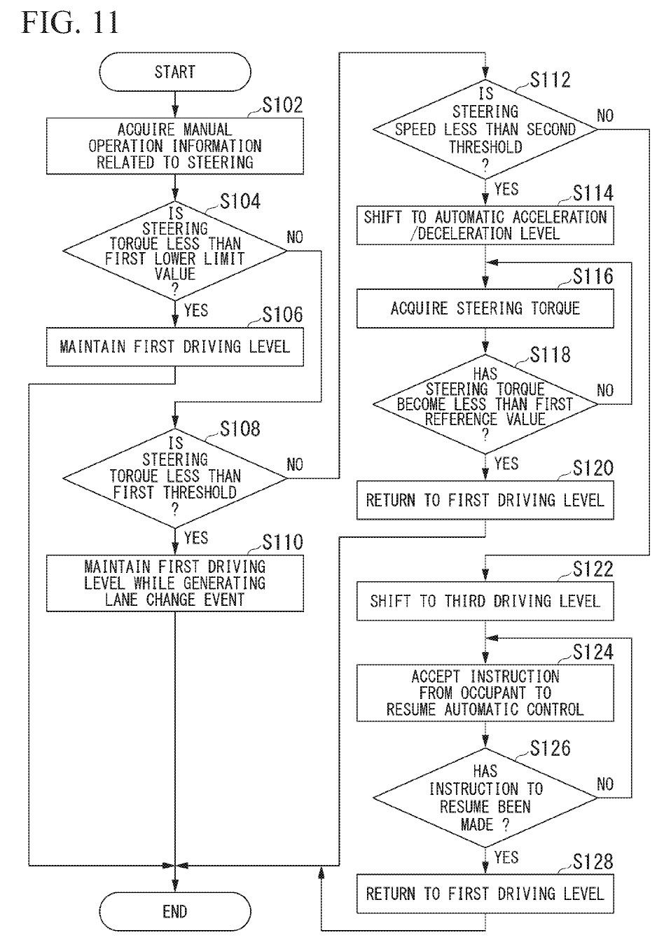

FIG. 11 is a flowchart showing an example of a flow of processing executed by the automated driving control device 100 when a manual operation related to steering is performed during execution of automated driving.

In the example of FIG. 11, the acquisition unit 151 acquires manual operation information related to steering (step S102). Next, the driving level determination unit 152 determines whether or not a steering torque is less than a first lower limit value based on the acquired manual operation information (step S104). When it is determined that the steering torque is less than the first lower limit value (step S104; YES), the driving level determination unit 152 maintains a driving level at the first driving level.

Thereby, normal automated driving (that is, automated driving without an override based on manual operation information) based on the first driving level is maintained (step S106). With this, the processing of the present flowchart ends.

When it is determined that the steering torque is not less than the first lower limit value (step S104; NO), the driving level determination unit 152 determines whether or not the steering torque is less than a first threshold based on the acquired manual operation information (step S108). That is, in processing of step S108, the driving level determination unit 152 determines whether or not the acquired manual operation information related to steering satisfies the first condition. When it is determined that the steering torque is less than the first threshold (step S108; YES), the driving level determination unit 152 causes the action plan generation unit 140 to generate a lane change event while maintaining a driving level at the first driving level (step S110). With this, the processing of the present flowchart ends.

When it is determined that the steering torque is not less than the first threshold (step S108; NO), the driving level determination unit 152 determines whether or not a steering speed is less than a second threshold based on the acquired manual operation information (step S112). That is, in processing of step S112, the driving level determination unit 152 determines whether or not the acquired manual operation information related to steering satisfies the second condition. When it is determined that the steering speed is less than the second threshold (step S112; YES), the driving level determination unit 152 shifts a driving level from the first driving level to the automatic acceleration/deceleration level (step S114). Thereafter, the acquisition unit 151 acquires a steering torque (step S116), and the driving level determination unit 152 determines whether or not the steering torque has become less than a first reference value (step S118). Processing of step S116 and step S118 is repeated until it is determined that the steering torque has become less than the first reference value (step S118; NO). When it is determined that the steering torque has become less than the first reference value (step S118; YES), the driving level determination unit 152 returns a driving level from the automatic acceleration/deceleration level to the first driving level (step S120). With this, the processing of the present flowchart ends.

When it is determined that the steering speed is not less than the second threshold (step S112; NO), the driving level determination unit 152 shifts a driving level from the first driving level to the third driving level (step S122). Thereafter, the acquisition unit 151 accepts an instruction from an occupant to resume automatic control (step S124), and the driving level determination unit 152 determines whether or not an instruction to resume automatic control has been made (step S126). Processing of step S124 and step S126 is repeated until it is determined that an instruction to resume automatic control has been made (step S126; NO). When it is determined that an instruction to resume automatic control has been made (step S126; YES), the driving level determination unit 152 returns a driving level from the third driving level to the first driving level (step S128). With this, the processing of the present flowchart ends.

When a Manual Operation Related to Acceleration/Deceleration is Performed During Execution of Automated Driving

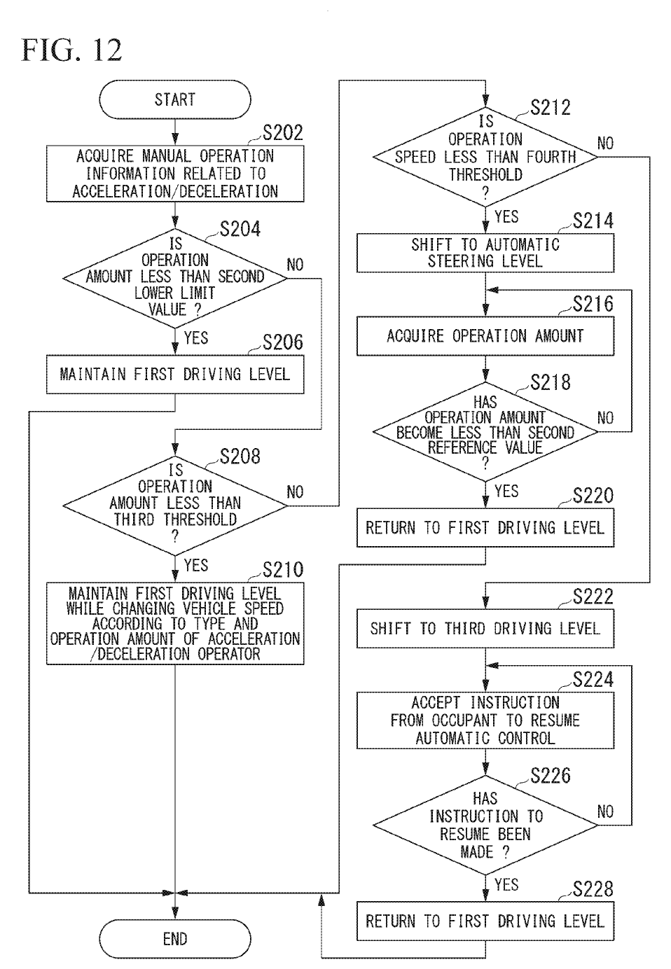

FIG. 12 is a flowchart showing an example of a flow of processing executed by the automated driving control device 100 when a manual operation related to acceleration/deceleration is performed during execution of automated driving.

In the example of FIG. 12, the acquisition unit 151 acquires manual operation information related to acceleration/deceleration (step S202). Next, the driving level determination unit 152 determines whether or not an operation amount of an acceleration/deceleration operator is less than a second lower limit value based on the acquired manual operation information (step S204). When it is determined that the operation amount is less than the second lower limit value (step S204; YES), the driving level determination unit 152 maintains a driving level at the first driving level. Thereby, normal automated driving (that is, automated driving without an override based on manual operation information) based on the first driving level is maintained (step S206). With this, the processing of the present flowchart ends.

When it is determined that the operation amount is not less than the second lower limit value (step S204; NO), the driving level determination unit 152 determines whether or not the operation amount is less than a third threshold based on the acquired manual operation information (step S208). That is, in processing of step S208, the driving level determination unit 152 determines whether or not the acquired manual operation information related to acceleration/deceleration satisfies the first condition. When it is determined that the operation amount is less than the third threshold (step S208; YES), the driving level determination unit 152 causes the action plan generation unit 140 to generate a target trajectory (speed element) for accelerating or decelerating the vehicle M by a predetermined value (for example, 5 [km/h]) according to a type and an operation amount of the acceleration/deceleration operator while maintaining a driving level at the first driving level (step S110). For example, when manual operation information related to an acceleration operator is acquired in step S202, the driving level determination unit 152 may cause the action plan generation unit 140 to generate a target trajectory for accelerating the vehicle M by a predetermined value. Alternatively, when manual operation information related to a deceleration operator is acquired in step S202, the driving level determination unit 152 may cause the action plan generation unit 140 to generate a target trajectory for decelerating the vehicle M by a predetermined value. With this, the processing of the present flowchart ends.

When it is determined that the operation amount is not less than the third threshold (step S208; NO), the driving level determination unit 152 determines whether or not an operation speed of the acceleration/deceleration operator is less than a fourth threshold based on the acquired manual operation information (step S212). That is, in processing of step S212, the driving level determination unit 152 determines whether or not the acquired manual operation information related to acceleration/deceleration satisfies the second condition. When it is determined that the operation speed is less than the fourth threshold (step S212; YES), the driving level determination unit 152 shifts a driving level from the first driving level to the automatic steering level (step S214). Thereafter, the acquisition unit 151 acquires an operation amount of the acceleration/deceleration operator (step S216), and the driving level determination unit 152 determines whether or not the operation amount has become less than a second reference value. Processing of step S216 and step S218 is repeated until it is determined that the operation amount has become less than the second reference value (step S218; NO). When it is determined that the operation amount has become less than the second reference value (step S218; YES), the driving level determination unit 152 returns a driving level from the automatic steering level to the first driving level (step S220). With this, the processing of the present flowchart ends.

When it is determined that the operation speed is not less than the fourth threshold (step S212; NO), the driving level determination unit 152 shifts a driving level from the first driving level to the third driving level (step S222). Thereafter, the acquisition unit 151 accepts an instruction from an occupant to resume automatic control (step S224), and the driving level determination unit 152 determines whether or not an instruction to resume automatic control has been made (step S226). Processing of step S224 and step S226 is repeated until it is determined that an instruction to resume automatic control has been made (step S226; NO). When it is determined that an instruction to resume automatic control has been made (step S226; YES), the driving level determination unit 152 returns a driving level from the third driving level to the first driving level (step S228). With this, the processing of the present flowchart ends.

According to the embodiment described above, the automated driving control device 100 (an example of a travel control device) includes a travel control unit (the action plan generation unit 140, the driving level determination unit 152, the processing unit 154, and the second control unit 160) that automatically controls acceleration/deceleration and steering of the vehicle M, and a manual operation acquisition unit (the acquisition unit 151) that acquires manual operation information related to a manual operation performed by an occupant of the vehicle M, wherein when manual operation information related to one of acceleration/deceleration and steering is acquired, and manual operation information related to the other of acceleration/deceleration and steering is not acquired, the travel control unit, when the manual operation information satisfies a first condition, continues both automatic control related to acceleration/deceleration and automatic control related to steering while changing control content of the automatic control according to the manual operation information satisfying the first condition, and when the manual operation information satisfies a second condition in which an operation intensity is greater than in the first condition, cancels automatic control related to that of acceleration/deceleration and steering for which the manual operation information has been acquired, and continues automatic control related to that of acceleration/deceleration and steering for which the manual operation information has not been acquired. Thereby, driving control according to an occupant's intention can be executed. This can ultimately contribute to development of a sustainable transportation system.

For example, in automated driving in which a manual operation related to the vehicle M is not imposed on an occupant, if a part or all of automated driving is immediately canceled when an occupant performs a manual operation, the occupant may feel bothered. According to the embodiment, changing of content of automatic control while continuing automated driving and switching from automated driving to semi-automated driving are selectively used according to intensity of a manual operation by an occupant. Thereby, driving control according to an occupant's intention can be executed.

### Modifications

Content of the first condition, the second condition, and the third condition can be appropriately changed. For example, when manual operation information related to steering is acquired, the second condition may be performing a lane change, and the third condition may be performing a right or left turn. More specifically, the second condition may be that a lane change is recognized by the recognition unit 130, and the third condition may be that a right or left turn is recognized by the recognition unit 130. Here, in a case of a lane change, there is a low possibility that a road attribute such as a speed limit or a width changes, and in a right or left turn, there is a high possibility that a road attribute changes. By making the second condition a lane change and the third condition a right or left turn, a shift from automated driving to semi-automated driving or manual driving can be determined according to a possibility of a change in a road attribute. Presence or absence of a lane change and presence or absence of a right or left turn may be determined on the basis of manual operation information. In this case, a condition of manual operation information for determining presence or absence of a lane change and presence or absence of a right or left turn may be stored in advance in the storage 190 as a part of the change condition information 194. Then, the driving level determination unit 152 may determine whether or not the second condition is satisfied and whether or not the third condition is satisfied on the basis of manual operation information acquired by the acquisition unit 151 and the change condition information 194 stored in the storage 190.

The automated driving control device 100 may automatically control, in addition to acceleration/deceleration and steering of the vehicle M, another operation (hereinafter referred to as an auxiliary operation) of the vehicle M in the first driving level (automated driving). In this case, the auxiliary operation may be automatically controlled by the automated driving control device 100 also in the second driving level and the third driving level. That is, when shifting from the first driving level to the second driving level or the third driving level, automatic control related to the auxiliary operation may be continued. However, the automated driving control device 100 may be configured not to perform automatic control related to the auxiliary operation in at least one of the second driving level and the third driving level.

The embodiment described above can be expressed as follows.

A storage medium storing computer-readable instructions, and

a processor connected to the storage medium, wherein

the processor executes the computer-readable instructions to

automatically control acceleration/deceleration and steering of a vehicle,

acquire manual operation information related to a manual operation performed by an occupant of the vehicle,

when manual operation information related to one of the acceleration/deceleration and the steering is acquired, and manual operation information related to the other of the acceleration/deceleration and the steering is not acquired, when the manual operation information satisfies a first condition, continue both the automatic control related to the acceleration/deceleration and the automatic control related to the steering while changing control content of the automatic control according to the manual operation information satisfying the first condition, and

when the manual operation information satisfies a second condition in which an operation intensity is greater than in the first condition, cancel the automatic control related to that of the acceleration/deceleration and the steering for which the manual operation information has been acquired, and continue the automatic control related to that of the acceleration/deceleration and the steering for which the manual operation information has not been acquired.

As above, although a form for performing the present invention has been described using the embodiment, the present invention is not limited to such an embodiment at all, and various modifications and substitutions can be applied within a range not departing from the concept of the present invention.

What is claimed is:

1. A travel control device comprising:
a travel control unit that automatically controls acceleration/deceleration and steering of a vehicle; and
a manual operation acquisition unit that acquires manual operation information related to a manual operation performed by an occupant of the vehicle, wherein
when the manual operation information related to one of the acceleration/deceleration and the steering is acquired, and the manual operation information related to the other of the acceleration/deceleration and the steering is not acquired, the travel control unit,
when the manual operation information satisfies a first condition, continues both the automatic control related to the acceleration/deceleration and the automatic control related to the steering while changing control content of the automatic control according to the manual operation information satisfying the first condition, and
when the manual operation information satisfies a second condition in which an operation intensity is greater than in the first condition, cancels the automatic control related to that of the acceleration/deceleration and the steering for which the manual operation information has been acquired, and continues the automatic control related to that of the acceleration/deceleration and the steering for which the manual operation information has not been acquired.

2. The travel control device according to claim 1, wherein
when the manual operation information related to the steering is acquired,
the first condition is that both a steering operation amount and a steering speed are less than a threshold, and
the second condition is that one of the steering operation amounts and the steering speed is equal to or greater than a threshold, and the other of the steering operation amount and the steering speed is less than a threshold.

3. The travel control device according to claim 2, wherein
the second condition is that the steering operation amount is equal to or greater than a threshold, and the steering speed is less than a threshold.

4. The travel control device according to claim 1, wherein
the travel control unit cancels both the automatic control related to the acceleration/deceleration and the automatic control related to the steering when the manual operation information satisfies a third condition in which an operation intensity is greater than the second condition.

5. The travel control device according to claim 4, wherein
when the manual operation information related to the steering is acquired,
the third condition is that both the steering operation amount and the steering speed are equal to or greater than a threshold.

6. The travel control device according to claim 4, wherein
when the manual operation information related to the steering is acquired,
the second condition is performing a lane change, and
the third condition is performing a right or left turn.

7. The travel control device according to claim 1, wherein
when the manual operation information related to the acceleration/deceleration is acquired,
the first condition is that both an operation amount of an acceleration/deceleration operator and an operation speed of the acceleration/deceleration operator are less than a threshold, and
the second condition is that one of the operation amounts of the acceleration/deceleration operator and the operation speed of the acceleration/deceleration operator is equal to or greater than a threshold, and the other of the operation amount of the acceleration/deceleration operator and the operation speed of the acceleration/deceleration operator is less than a threshold.

8. The travel control device according to claim 4, wherein
when the manual operation information related to the acceleration/deceleration is acquired,
the third condition is that both the operation amount of the acceleration/deceleration operator and the operation speed of the acceleration/deceleration operator are equal to or greater than a threshold.

9. A travel control method in which a computer
automatically controls acceleration/deceleration and steering of a vehicle,
acquires manual operation information related to a manual operation performed by an occupant of the vehicle, and
when the manual operation information related to one of the acceleration/decelerations and the steering is acquired, and the manual operation information related to the other of the acceleration/deceleration and the steering is not acquired,
when the manual operation information satisfies a first condition, continues both the automatic control related to the acceleration/deceleration and the automatic control related to the steering while changing control content of the automatic control according to the manual operation information satisfying the first condition, and
when the manual operation information satisfies a second condition in which an operation intensity is greater than in the first condition, cancels the automatic control related to that of the acceleration/deceleration and the steering for which the manual operation information has been acquired, and continues the automatic control related to that of the acceleration/deceleration and the steering for which the manual operation information has not been acquired.

10. A computer-readable non-transitory storage medium storing a program that causes a computer to
automatically control acceleration/deceleration and steering of a vehicle,
acquire manual operation information related to a manual operation performed by an occupant of the vehicle, and
when the manual operation information related to one of the acceleration/decelerations and the steering is acquired, and the manual operation information related to the other of the acceleration/deceleration and the steering is not acquired,
when the manual operation information satisfies a first condition, continue both the automatic control related to the acceleration/deceleration and the automatic control related to the steering while changing control content of the automatic control according to the manual operation information satisfying the first condition, and
when the manual operation information satisfies a second condition in which an operation intensity is greater than in the first condition, cancel the automatic control related to that of the acceleration/deceleration and the steering for which the manual operation information has been acquired, and continue the automatic control related to that of the acceleration/deceleration and the steering for which the manual operation information has not been acquired.
